(19) United States
(12) Patent Application Publication
(10) Pub. No.: US 2026/0216857 A1
(43) Pub. Date: Jul. 30, 2026

(54) TOOL STORAGE DEVICE

(71) Applicant: CHUN NIEN PLASTIC LTD., Taichung City (TW)

(72) Inventor: CHI-TSAI CHANG, Taichung City (TW)

(21) Appl. No.: 19/458,056

(22) Filed: Jan. 23, 2026

(30) Foreign Application Priority Data
Jan. 24, 2025 (TW) 114103277

(51) Int. Cl. B25H 3/00

(52) U.S. Cl. CPC B25H 3/003

(57) ABSTRACT

A tool storage device is provided, wherein the tool storage device includes: a base including a rail slot, the rail slot extending in an extension direction, wherein two blocking portions protrude from opposite sides of the base toward each other, each of the two blocking portions includes a plurality of protrusions and a plurality of recesses arranged at intervals, and the plurality of protrusions and the plurality of recesses are alternately arranged along the extension direction.

### BACKGROUND OF THE INVENTION

### Field of the Invention

The present invention relates to a storage device, particularly to a tool storage device.

### Description of the Prior Art

A conventional tool hanging device is assembled with one or a plurality of tools to facilitate storage and carrying. The conventional tool hanging device includes a slidable holder and a plurality of slidable bases slidably disposed on the slidable holder, and the plurality of slidable bases are for inserting and connecting a plurality of tools.

In the conventional tool hanging device, the slidable holder is made of metal, and the processing design is much limited. In addition, the slidable holder has a poor anti-slip effect, causing the slidable bases to be easily loosened or to wobble during use. Especially during carrying or vertical display for sale, the slidable bases are more likely to move relative to the slidable holder due to gravity or external force, and may even collide with each other. This not only may affect the stability and neatness of the tools, but also may cause noise during display for sale or use, or cause problems such as tool damage.

The present invention is, therefore, arisen to obviate or at least mitigate the above-mentioned disadvantages.

### SUMMARY OF THE INVENTION

The main object of the present invention is to provide a tool storage device which has a simple structure and can prevent a tool holder from sliding arbitrarily.

To achieve the above and other objects, a tool storage device is provided, wherein the tool storage device includes: a base including a rail slot, the rail slot extending in an extension direction, wherein two blocking portions protrude from opposite sides of the base toward each other, each of the two blocking portions includes a plurality of protrusions and a plurality of recesses arranged at intervals, and the plurality of protrusions and the plurality of recesses are alternately arranged along the extension direction.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is another exploded view of an exemplary embodiment of the present invention;

FIG. 4 is a schematic view of installation of a cover of an exemplary embodiment of the present invention;

FIG. 5 is a cross-sectional view of an exemplary embodiment of the present invention;

FIG. 6 is a perspective view showing a use state of an exemplary embodiment of the present invention; and

FIG. 7 is a cross-sectional view showing a use state of an exemplary embodiment of the present invention.

### DETAILED DESCRIPTION OF THE PREFERRED EMBODIMENTS

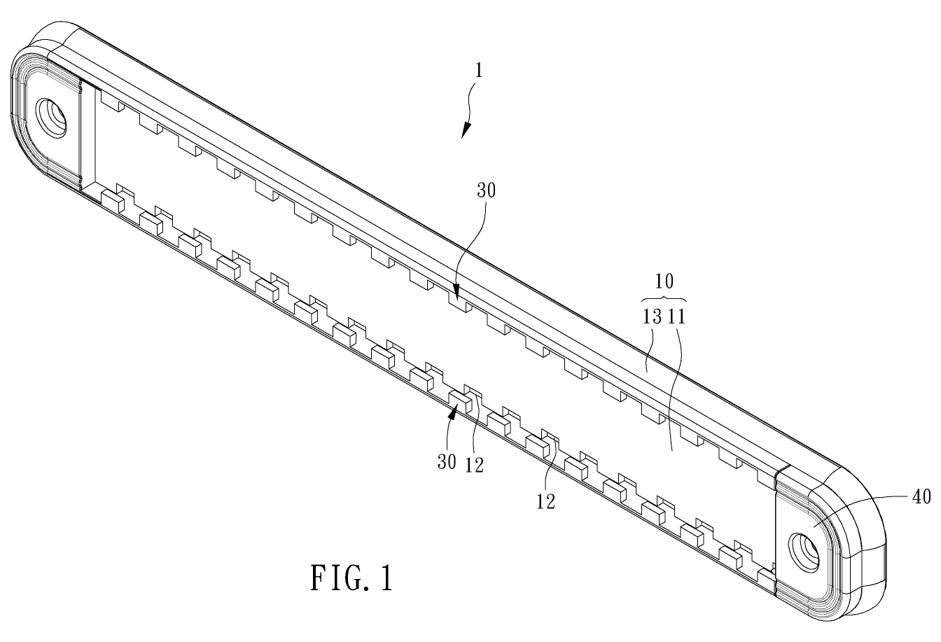

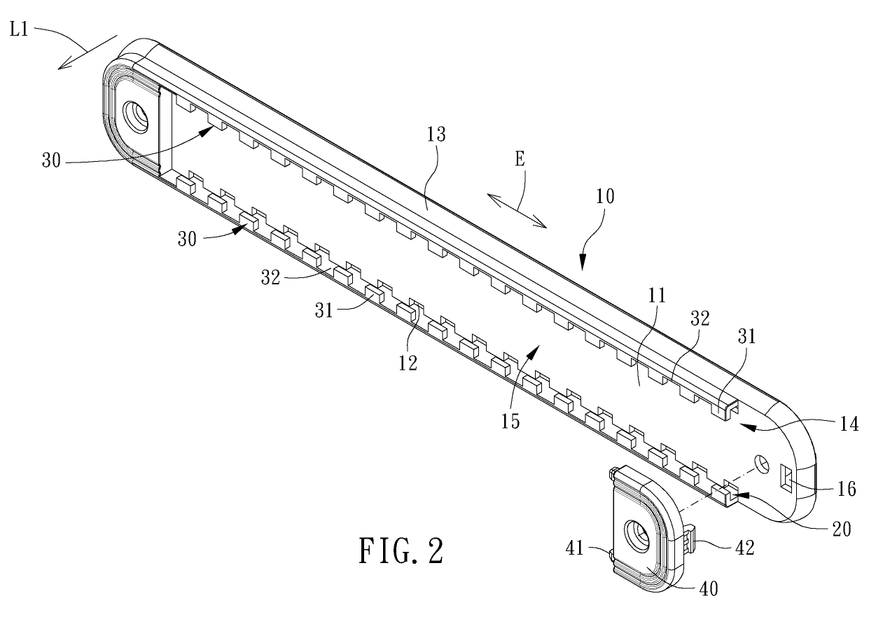

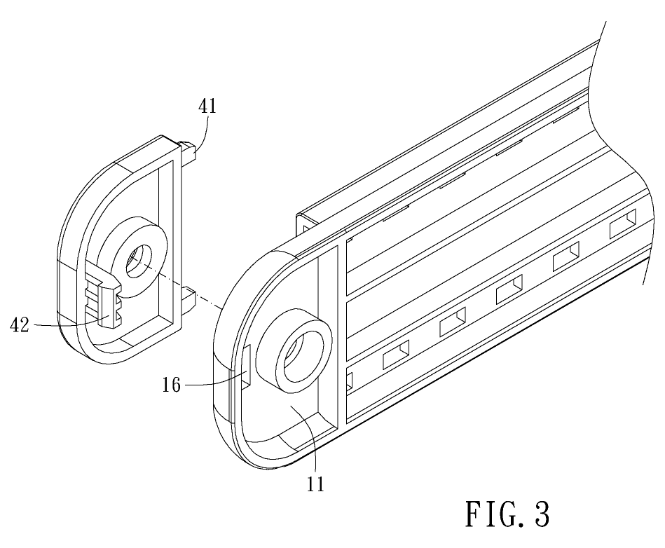

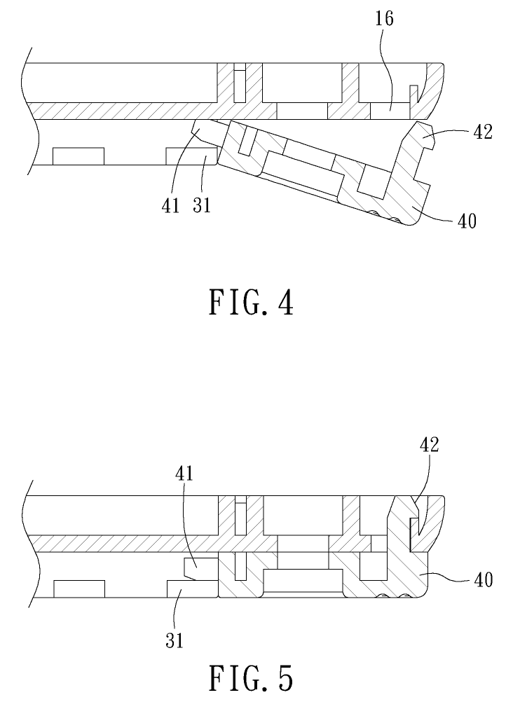

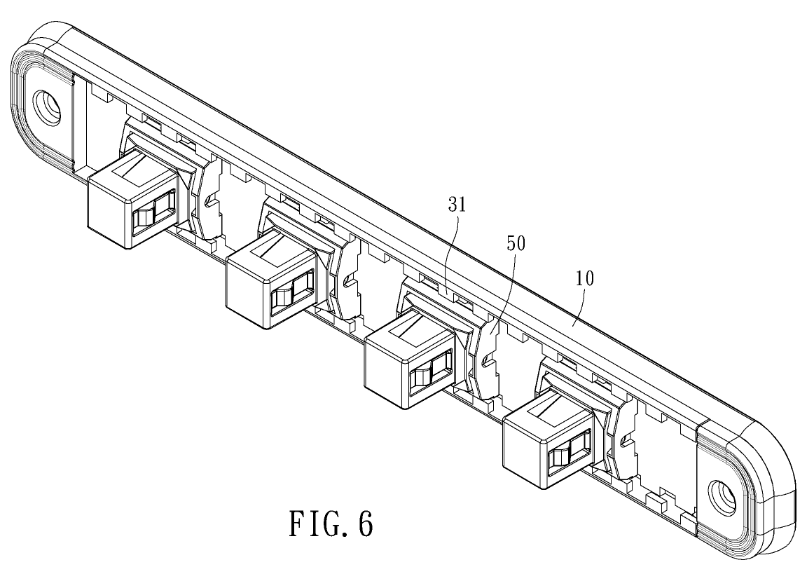

Please refer to FIGS. 1 to 7 for an exemplary embodiment of the present invention. A tool storage device 1 of the present invention includes a base 10.

The base 10 includes a rail slot 20, the rail slot 20 extends in an extension direction E, wherein two blocking portions 30 protrude from opposite sides of the base 10 toward each other, each of the two blocking portions 30 includes a plurality of protrusions 31 and a plurality of recesses 32 arranged at intervals, and the plurality of protrusions 31 and the plurality of recesses 32 are alternately arranged along the extension direction E. Specifically, a side opening 15 is formed between the two blocking portions 30, and the side opening 15 is in communication with the rail slot 20.

In this embodiment, the tool storage device 1 further includes a tool holder 50 slidably disposed in the rail slot 20, wherein the two blocking portions 30 block the tool holder 50 in a direction transverse to the extension direction E. The tool holder 50 is for mounting a tool such as a socket, a screwdriver bit, or the like.

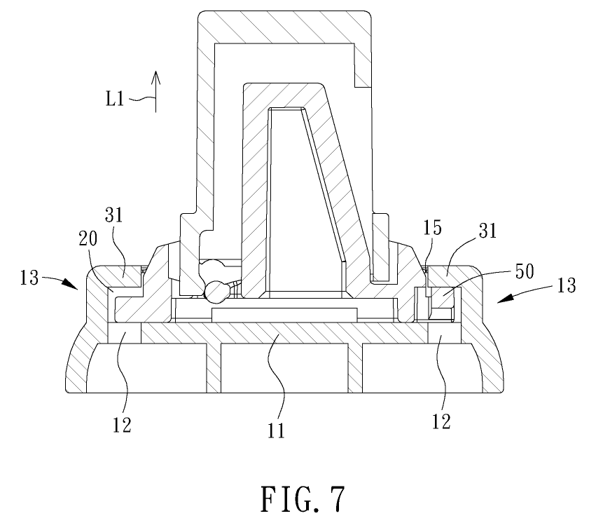

As such, a plurality of concave-convex interference and engagement regions are formed between an adjacent protrusion 31 and recess 32, so that an uneven surface is formed. Any one of the protrusions 31 can be in contact with the tool holder 50 as shown in FIG. 7, so as to increase resistance with a simple structure, thereby preventing the tool holder 50 from arbitrarily sliding, rotating and loosening, and providing a good positioning effect.

Specifically, a bottom 11 of the base 10 faces the two blocking portions 30 in a first direction L1, the first direction L1 is transverse to the extension direction E, and each of the plurality of recesses 32 is open in the first direction L1 and toward each other. Therefore, the tool holder 50 can pass through any one of the recesses 32 easily to engage and abut against one of the protrusions 31.

The base 10 may be formed by plastic injection molding. With the plurality of recesses 32, the base 10 can be removed from a mold in the first direction L1 (a thickness direction of the base 10). A shorter mold opening distance can be used to complete demolding, thereby reducing a requirement for production space and improving overall flexibility of production line arrangement.

The base 10 further includes two side portions 13, the two side portions 13 are transversely disposed on opposite sides of the bottom 11, each of the two side portions 13 includes one of the two blocking portions 30, and the two blocking portions 30 are spaced apart from the bottom 11. In this embodiment, the bottom 11, the two side portions 13 and the two blocking portions 30 are integrally formed of one piece from a plastic material, which is easy to machine and form, so that the design may be diversified and manufacturing is easy. In addition, the base 10 is an insulator, and each of the plurality of protrusions 31 is elastically movable relative to the rail slot 20, so that each of the protrusions 31 can elastically engage and abut against the tool holder 50. The bottom 11 of the base 10 includes at least one through hole 12, and the at least one through hole 12 corresponds to at least one of the plurality of protrusions 31. Specifically, the at least one through hole 12 is disposed adjacent to one of the two side portions 13, so as to reduce a contact area between the bottom 11 and each of the side portions 13, thereby increasing a swingable range of each of the side portions 13 relative to the bottom 11. Preferably, the at least one through hole includes a plurality of through holes 12, the plurality of through holes 12 are spaced apart from each other, so that the base 10 has high structural strength. Furthermore, the plurality of through holes 12 are for allowing a demolding mechanism to pass through or allowing other mold mechanisms to pass through, thereby facilitating demolding and manufacturing of the base 10.

The base 10 is an elongated member extending in the extension direction E, the base 10 further includes an end opening 14, the end opening 14 is open in the extension direction E, and a cover 40 covers the end opening 14. An insertion portion 41 of the cover 40 is inserted in the rail slot 20 and located between at least two of the plurality of protrusions 31 and the bottom 11 of the base 10. In this embodiment, the insertion portion 41 includes two engagement protrusions disposed at intervals. The two engagement protrusions are respectively engaged in the rail slot 20 and are blocked by at least one of the protrusions 31 of one of the blocking portions 30 in the first direction L1, so as to prevent disengagement. Therefore, with a simple structure, the end opening 14 is closed. Moreover, one of the cover 40 and the bottom 11 includes a buckle hole 16, the other of the cover 40 and the bottom 11 includes a buckle portion 42, and the buckle portion 42 is detachably buckled to the buckle hole 16. In this embodiment, the cover 40 includes the buckle portion 42, and the bottom 11 includes the buckle hole 16, so that the cover 40 can be fastened to the base 10. The cover 40 includes a hanging hole, and the hanging hole is for hanging.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool storage device including:
a base including a rail slot, the rail slot extending in an extension direction, wherein two blocking portions protrude from opposite sides of the base toward each other, each of the two blocking portions includes a plurality of protrusions and a plurality of recesses arranged at intervals, and the plurality of protrusions and the plurality of recesses are alternately arranged along the extension direction.

2. The tool storage device of claim 1, wherein a bottom of the base faces the two blocking portions in a first direction, the first direction is transverse to the extension direction, and each of the plurality of recesses is open in the first direction and toward each other.

3. The tool storage device of claim 1, wherein the base includes a bottom and two side portions, the two side portions are transversely disposed on opposite sides of the bottom, each of the two side portions includes one of the two blocking portions, and the two blocking portions are spaced apart from the bottom.

4. The tool storage device of claim 3, wherein the bottom of the base includes at least one through hole, and the at least one through hole corresponds to at least one of the plurality of protrusions.

5. The tool storage device of claim 4, wherein the at least one through hole is disposed adjacent to one of the two side portions.

6. The tool storage device of claim 3, wherein the bottom, the two side portions and the two blocking portions are integrally formed of one piece from a plastic material.

7. The tool storage device of claim 1, wherein each of the plurality of protrusions is elastically movable relative to the rail slot.

8. The tool storage device of claim 1, wherein the base is an elongated member extending in the extension direction, the base further includes an end opening, the end opening is open in the extension direction, a cover covers the end opening, and an insertion portion of the cover is inserted in the rail slot and located between at least two of the plurality of protrusions and a bottom of the base.

9. The tool storage device of claim 1, further including a tool holder slidably disposed in the rail slot, wherein the two blocking portions block the tool holder in a direction transverse to the extension direction.

10. The tool storage device of claim 5, wherein the bottom of the base faces the two blocking portions in a first direction, the first direction is transverse to the extension direction, and each of the plurality of recesses is open in the first direction and toward each other; an side opening is formed between the two blocking portions, the side opening is in communication with the rail slot; the at least one through hole includes a plurality of through holes, the plurality of through holes correspond to the plurality of protrusions, and the plurality of through holes are spaced apart from each other; the base is an insulator, and each of the plurality of protrusions is elastically movable relative to the rail slot; the bottom, the two side portions, and the two blocking portions are integrally formed of one piece from a plastic material; the base is an elongated member extending in the extension direction, the base further includes an end opening, and the end opening is open in the extension direction, and a cover covers the end opening; an insertion portion of the cover is inserted in the rail slot and located between at least two of the plurality of protrusions and the bottom of the base; and one of the cover and the bottom includes a buckle hole, the other of the cover and the bottom includes a buckle portion, and the buckle portion is detachably buckled to the buckle hole.
